(19) United States
(12) Patent Application Publication
(10) Pub. No.: US 2008/0210486 A1
(43) Pub. Date: Sep. 4, 2008

(54) Energy attenuation device

(75) Inventor: Yungrwei Chen, West Bloomfield, MI (US)

Correspondence Address: DAYCO PRODUCTS, LLC, 1 PRESTIGE PLACE, MIAMISBURG, OH, 45342, US

(73) Assignee: DAYCO PRODUCTS, LLC, Miamisburg, OH (US)

(21) Appl. No.: 11/713,644

(22) Filed: Mar. 2, 2007

(51) Int. Cl. B62D 5/08

(52) U.S. Cl. 180/441

(57) ABSTRACT

An energy attenuation device for a liquid-conveying line, comprising metal tubing disposed in the liquid-conveying line, a spring disposed in the metal tubing, and a spring-retaining device associated with the metal tubing to prevent or limit movement of the spring in the metal tubing in a downstream direction.

### BACKGROUND OF THE INVENTION

1. Field of the Invention

The present application relates to an energy attenuation device for a liquid-conveying line, especially one that is adapted to convey a pressurized liquid therethrough.

Such a device is particularly suitable for placement in such a liquid-conveying line for the attenuation of pressure pulses in the liquid, especially in the hydraulic system of the power steering unit of a vehicle. However, the device of the present application would also be suitable for other hydraulic fluids.

2. Prior Art Statement

In hydraulic systems where the operating liquid is circulated by a pump, the pulsations of pressure that are generated by the pump are transmitted through the conduits and result in noise and/or vibration being produced by the hydraulic fluid. In the case of power steering fluid in vehicles, such noise and/or vibration is caused, for example, when vehicles are being parked or unparked at idle or very low speeds of movement of the vehicle, such as by barely moving into and out of a parking space or the like while the wheels of the vehicle are being turned by the power steering mechanism thereof. In particular, substantial noise and/or vibration (shudder) can be produced in such a situation when the power steering fluid passes through the power steering mechanism from the fluid pump to the effective steering structure. Further background in this area can be obtained from U.S. Pat. No. 3,323,305, Klees, whereby this U.S. patent is being incorporated into this disclosure by this reference thereto.

It is therefore an object of the present application to provide a new device for attenuating energy in a liquid-conveying line, in particular in a line that conveys fluid under pressure.

### SUMMARY OF THE INVENTION

This object is realized by an energy attenuation device that comprises metal tubing disposed in the liquid-conveying line, a spring disposed in the metal tubing, and a spring-retaining means associated with the metal tubing to prevent or limit movement of the spring in the metal tubing in a downstream direction.

### BRIEF DESCRIPTION OF THE DRAWINGS

Other objects, uses and advantages of this invention are apparent from a reading of the specification in conjunction with the accompanying schematic drawings, which form a part thereof and wherein:

FIG. 1 illustrates a simplified automotive power steering system into which is to be incorporated an embodiment of the energy attenuation device of this application;

FIGS. 2 and 3 show exemplary embodiments of energy attenuation devices of this application;

FIGS. 4 and 5 are enlarged partial views of exemplary embodiments of energy attenuation devices of this application; and

FIG. 6 shows another exemplary embodiment of an energy attenuation device of this application.

### DESCRIPTION OF SPECIFIC EMBODIMENTS

While the various features of this invention are hereinafter illustrated and described as providing a sound or energy attenuation device for an automotive power steering system, it is to be understood that the various features of this invention can be utilized singly or in various combinations thereof to provide an energy attenuation device for other systems that convey liquid, especially liquid under pressure. Therefore, this invention is not to be limited to only the embodiments illustrated in the drawings, because the drawings are merely utilized to illustrate one of the wide varieties of usages of this invention.

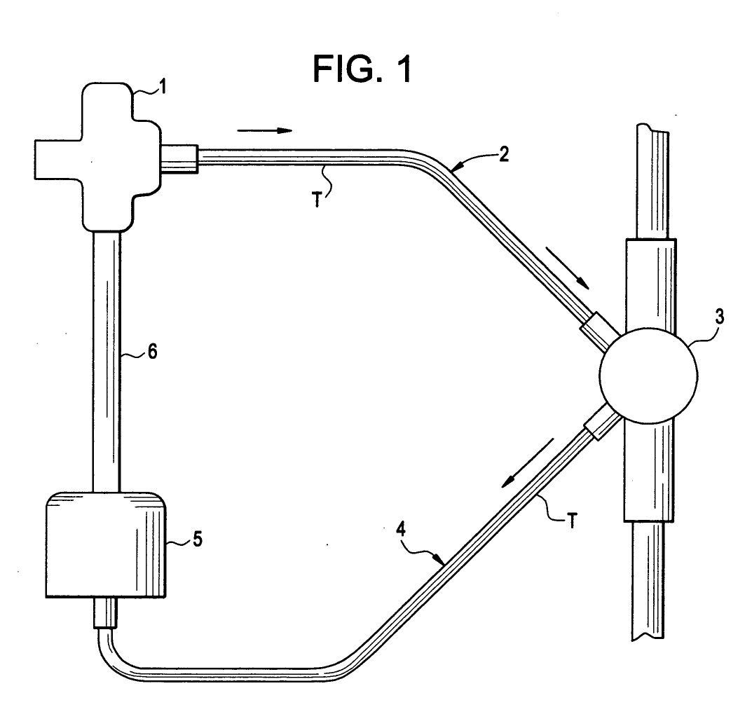

Referring now to the drawings in detail, FIG. 1 illustrates a simplified automotive power steering system. During operation, the power steering pump 1 generates pressure ripples that are transmitted through metal tubing T, as the pressure line 2, to the power steering gear 3, the return line 4, and a reservoir 5, and finally flow back to the pump 1 itself by means of the supply line 6. It should be noted that rather than being separated by a hose or similar conduit, the reservoir 5 and the pump 1 could actually be a single unit.

In order to greatly reduce noise, such as from resonance, for example in the pressure line 2 or in the return line 4, and thereby to eliminate or at least greatly reduce the power steering noise or vibration generated by the power steering pump 1 and/or by the power steering gear 3, the energy attenuation device of this application is disposed either in the return line 4, between the gear 3 and the reservoir 5 or the pump 1, or in the pressure line 2, between the steering pump 1 and the gear 3. In addition, it would also be conceivable to dispose the energy attenuation device of the present application in both the return line 4 and the pressure line 2.

Various exemplary embodiments of the energy attenuation device of the present application, which is indicated generally by the reference numeral 10, and components and arrangements thereof, are illustrated in the drawings and will be described in detail subsequently.

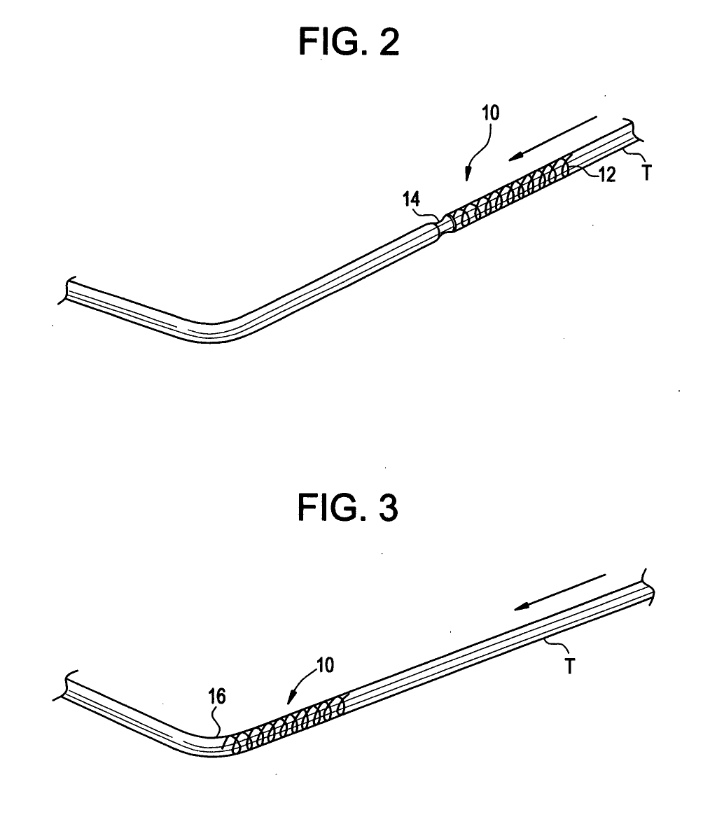

FIG. 2 shows one exemplary embodiment of an inventive energy attenuation device 10 disposed, for example, in the return line 4 or pressure line 2 of a power steering system. As can be seen, a spring 12 is disposed in the tubing T. In this embodiment, the spring 12 does not extend throughout the entire length of the tubing T. Rather, a spring retaining means 14 is disposed on the downstream side of the spring 12 to prevent or limit movement thereof in the tubing T, whereby in the illustrated embodiment the spring-retaining means 14 is in the form of a crimping or swaging that reduces the diameter of the tubing T such that the spring 12 cannot pass the location of the spring-retaining means 14. A further spring-retaining means 14 could also be disposed on an upstream side of the spring 12. The spring 12 could fill the entire area between the spring-retaining means 14, or the spring could have a limited range of movement within its section of the tubing T.

Although in the embodiment illustrated in FIG. 2 the spring-retaining means 14 is shown as a swaging, other means could also be provided to prevent or limit the movement of the spring 12. For example, the diameter of the spring 12 could be at least in part greater than the inner diameter of the tubing T, so that the spring 12 would at least at one location be wedged within the tubing T, thus preventing its movement therein. In addition, the spring-retaining means could be in the form of a rubber or plastic sleeve or ring that is press-fit into the tubing T and has an inner diameter that is less than the outer diameter of the spring 12, thus preventing movement of the spring past such a spring-retaining means. The spring-retaining means could also be in the form of a set screw that is threaded into the tubing T and extends into the interior thereof so as to prevent movement of the spring 12 past the location thereof. If the diameter of the spring 12 is nearly as great as the inner diameter of the tubing T, a bend in the tubing T, as shown at the location 16 in FIG. 3, may also be sufficient to provide a spring-retaining means downstream of the spring 12. Instead of swaging, a set screw, a sleeve or ring, etc., some other physical obstruction, such as an inwardly extending bump or protrusion, could also be provided on the inside of the tubing T to prevent movement of the spring 12 past that location.

At any rate, the spring-retaining means 14 is merely intended to prevent or limit movement of the spring 12 in the tubing T in a downstream direction, but still allow flow of liquid through the tubing T.

It is to be understood that characteristics such as length, thickness, tension, number of coils per unit length, etc. of the spring 12 of the energy attenuation device 10 of the present application can vary in conformity with existing requirements. In addition, the spring 12 can be made of any suitable material, such as metal, especially stainless steel, or plastic. The tubing T, on the other hand, is made of metal, such as steel, aluminum, or a copper/nickel alloy. By way of example only, the tubing T can have an outer diameter of 0.95 cm (⅜ inch) or 1.27 cm (½ inch). Of course, the diameter can also be smaller or larger.

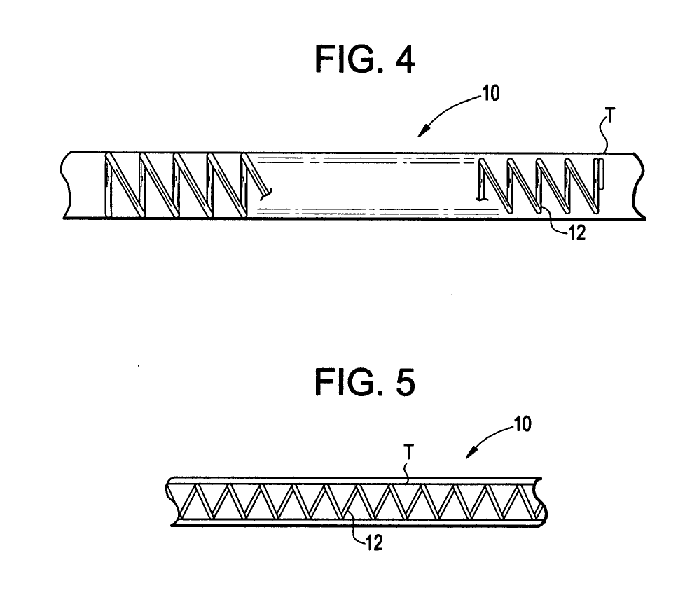

As indicated previously, the spring 12 could have a limited movement within the tubing T. In such a case, the outer diameter of the spring 12 would be at least slightly less than the inner diameter of the tubing T, as illustrated in FIG. 4. However, the spring 12 could also have a diameter that is slightly greater than the diameter of the tubing T, as shown in FIG. 5. In such a case, the spring would be wedged within the tubing T to prevent movement therein. Although in the embodiment shown in FIG. 5 the entire diameter of the spring 12 is greater than the inner diameter of the tubing T, it would be adequate for only a portion of the spring 12, such as an end or the middle thereof, to have a diameter that is greater than the inner diameter of the tubing T in order to provide a spring-retaining means.

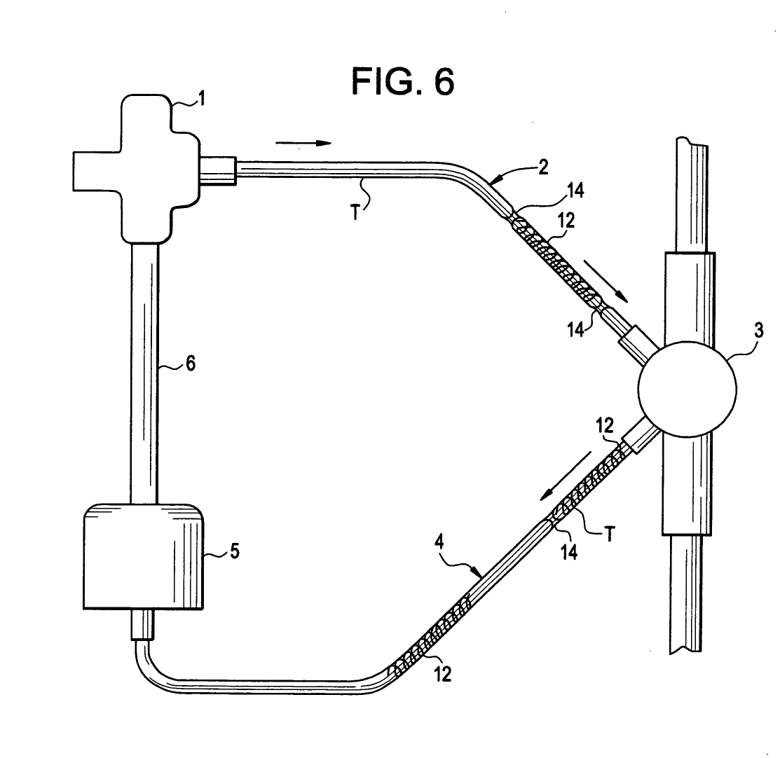

Although in the embodiments illustrated in FIGS. 2 and 3, only a single spring 12 has been shown, it would also be possible to provide two or more springs within one or more sections of one or more tubings T. For example, in the embodiment illustrated in FIG. 6, one spring 12 is shown in the pressure line 2 upstream of the power steering gear 3, while two further springs 12 are shown downstream of the gear 3 in the return line 4. Also shown are various spring-retaining means 14, 16. One of the springs 12 in the return line 4 is shown in the immediate downstream vicinity of the power steering gear 3; in addition to providing its energy attenuation function, this spring 12 that is close to the gear 3 helps to build up back pressure in the return line 4.

Although in the illustrated embodiments the springs 12 have been shown in straight sections of the tubing T, they could also be disposed in bent or curved sections of the tubing.

The present invention is, of course, in no way restricted to the specific disclosure of the specification and drawings, but also encompasses any modifications within the scope of the appended claims.

What is claimed is:

1. An energy attenuation device for a liquid-conveying line, comprising:
metal tubing disposed in said liquid-conveying line;
a spring disposed in said metal tubing; and
spring-retaining means associated with said metal tubing to prevent or limit movement of said spring in said metal tubing in a downstream direction.

2. An energy attenuation device according to claim 1, wherein said spring-retaining means is in the form of swaging of said metal tubing at a location adapted to be downstream of said spring.

3. An energy attenuation device according to claim 1, wherein said spring has an outer diameter that is at least in part greater than an inner diameter of said metal tubing to provide said spring-retaining means.

4. An energy attenuation device according to claim 1, wherein said spring-retaining means is a set screw disposed in said metal tubing and adapted to extend into an interior thereof.

5. An energy attenuation device according to claim 1, wherein said spring-retaining means is in the form of a rubber or plastic sleeve or ring disposed within said metal tubing.

6. An energy attenuation device according to claim 1, wherein said spring-retaining means is in the form of a bend of said metal tubing.

7. An energy attenuation device according to claim 1, wherein said spring extends over a length of said metal tubing or over only a portion of the length of said metal tubing.

8. An energy attenuation device according to claim 1, wherein further spring-retaining means are also disposed in a direction upstream of said spring.

9. An energy attenuation device according to claim 1, wherein an outer diameter of said spring is less than an inner diameter of said metal tubing.

10. An energy attenuation device according to claim 1, wherein at least one further spring is disposed in the same metal tubing or in one or more further metal tubings.

11. An energy attenuation device according to claim 1, wherein said spring is disposed in the vicinity of a power steering gear of a power steering system.

12. An energy attenuation device according to claim 11, wherein said spring is disposed downstream of said power steering gear.

13. A method of attenuating energy in a liquid-conveying line, including the steps of:
providing a metal tubing in the liquid-conveying line;
disposing a spring in said metal tubing; and
providing a spring-retaining means in association with said metal tubing to prevent or limit movement of said spring in said metal tubing in a downstream direction.
